(19) United States
(12) Patent Application Publication
(10) Pub. No.: US 2024/0381168 A1
(43) Pub. Date: Nov. 14, 2024

(54) TECHNOLOGIES FOR BUFFER DELAY REPORTING

(71) Applicant: Apple Inc., Cupertino, CA (US)

(72) Inventors: Ping-Heng Kuo, London (GB); Ralf Rossbach, Munich (DE)

(73) Assignee: Apple Inc., Cupertino, CA (US)

(21) Appl. No.: 18/633,443

(22) Filed: Apr. 11, 2024

Related U.S. Application Data
(60) Provisional application No. 63/501,627, filed on May 11, 2023.

(51) Int. Cl. H04W 28/02

(52) U.S. Cl. CPC H04W 28/0278

(57) ABSTRACT

The present application relates to devices and components including apparatus. systems, and methods for buffer delay reporting with configured grants in wireless networks.

### CROSS-REFERENCE TO RELATED APPLICATION

This application claims the benefit of U.S. Provisional Patent Application No. 63/501,627, filed on May 11, 2023, which is herein incorporated by reference in its entirety for all purposes.

### TECHNICAL FIELD

This application relates generally to communication networks and, in particular, to technologies for buffer delay reporting in such networks.

### BACKGROUND

Buffer status reports are important mechanisms for a user equipment (UE) to inform a base station on an amount of uplink data that has arrived in a buffer of the UE. The base station may use this information to allocate uplink resources to accommodate the buffered data.

### BRIEF DESCRIPTION OF THE DRAWINGS

FIG. 1 illustrates a network environment in accordance with some embodiments.

FIG. 2 illustrates a configured grant (CG) configuration in accordance with some embodiments.

FIG. 3 illustrates an operational flow/algorithmic structure in accordance with some embodiments.

FIG. 4 illustrates a timing diagram illustrating autonomous transmission in accordance with some embodiments.

FIG. 5 illustrates another operational flow/algorithmic structure in accordance with some embodiments.

FIG. 6 illustrates another operational flow/algorithmic structure in accordance with some embodiments.

FIG. 7 illustrates another operational flow/algorithmic structure in accordance with some embodiments.

FIG. 8 illustrates a user equipment in accordance with some embodiments.

FIG. 9 illustrates a base station in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer an application processor; baseband processor; a central processing unit (CPU); a graphics processing unit; a single-core processor; a dual-core processor; a triple-core processor; a quad-core processor; or any other device capable of executing or otherwise operating computer-executable instructions, such as program code; software modules; or functional processes.

The term “interface circuitry” as used herein refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to computer, storage, or network resources provided by physical hardware element(s). A “virtualized resource” may refer to computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

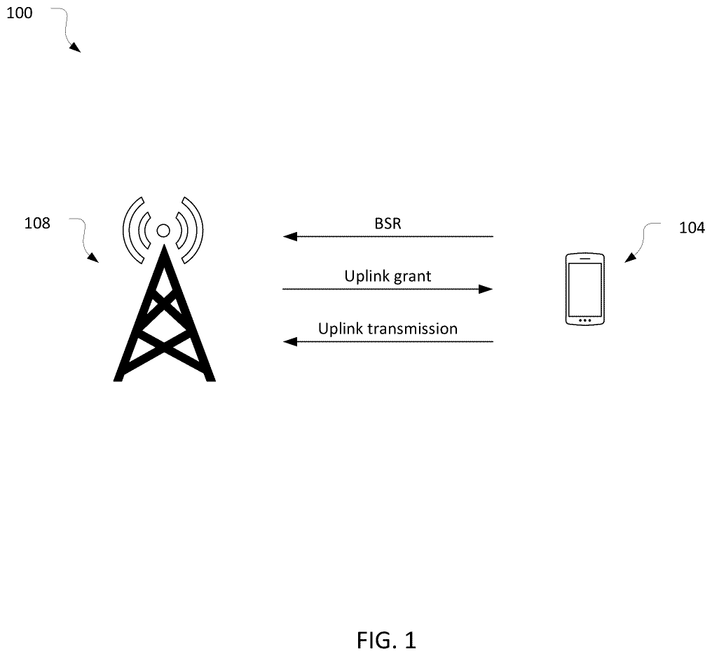

FIG. 1 illustrates a network environment 100 in accordance with some embodiments. The network environment 100 may include a UE 104 coupled with a base station (BS) 108 of a radio access network (RAN). In some embodiments, the base station 108 is a next-generation node B (gNB) that provides one or more 3GPP New Radio (NR) cells. In other embodiments, the base station 108 is an evolved node B (eNB) that provides one or more Long Term Evolution (LTE) cells. The air interface over which the UE 104 and base station 108 communicate may be compatible with 3GPP technical specifications, such as those that define Fifth Generation (5G) NR or later system standards.

The UE 104 may send a buffer status report (BSR) to the base station 108 to indicate an amount of uplink data that the UE 104 has to transmit. The BSR may be transmitted as a media access control (MAC) control element (CE) on a physical uplink shared channel (PUSCH). The BSR may be associated with at least one logical channel group (LCG) having one or more logical channels (LCHs). Upon receiving the BSR, the base station 108 may determine an appropriate amount of uplink resources for the UE 104. The base station 108 may then transmit an uplink grant to the UE 104. The UE 104 may use the UL grant for a subsequent uplink transmission.

Traffic types are evolving to accommodate new use cases in developing cellular networks. For example, efforts are being undertaken to improve RAN operation to support traffic having characteristics associated with extended reality (XR) traffic to provide, for example, high throughput, low-latency, and high reliability. Various enhancements to BSR operation may be used to improve capacity for XR use cases. While some embodiments are described with reference to XR traffic, other embodiments may apply similar concepts to other types of traffic.

BSRs may be enhanced for XR use cases by including additional types of information. Existing BSRs only provide information about a buffer size. In order to facilitate delay-aware scheduling for XR (or other) traffic that has latency constraints, the BSR may further include information relating to delay status of the buffered data. For example, the BSR may include an indication of how long the data has been queued or an amount of time that remains until a delivery deadline. Providing the buffer delay information with the BSR may allow the base station 108 to know how long the buffered data for an LCH/LCG has been waiting or how urgent it is to transmit the buffered data before a corresponding delivery deadline.

While some embodiments describe transmission of the buffer delay information with the BSR, in other embodiments it may be transmitted separately.

To provide the desire effect, the buffer delay information reported to the base station 108 must be up-to-date to provide the base station 108 with an accurate representation of the current situation. If the buffer delay information is outdated, the base station 108 may not be able to perform delay-aware scheduling in the appropriate manner.

Up-to-date reporting of buffer delay information may be challenged by various features of configured grant (CG) operation within wireless networks.

Reporting of buffer delay information may also be triggered when a number of padding bits in an uplink transmission opportunity is equal to or larger than a size of a MAC CE for buffer delay information reporting plus its subheader. The padding bits may refer to, for example, spare bits in a PUSCH of one configured grant or one dynamic grant after multiplexing of user data.

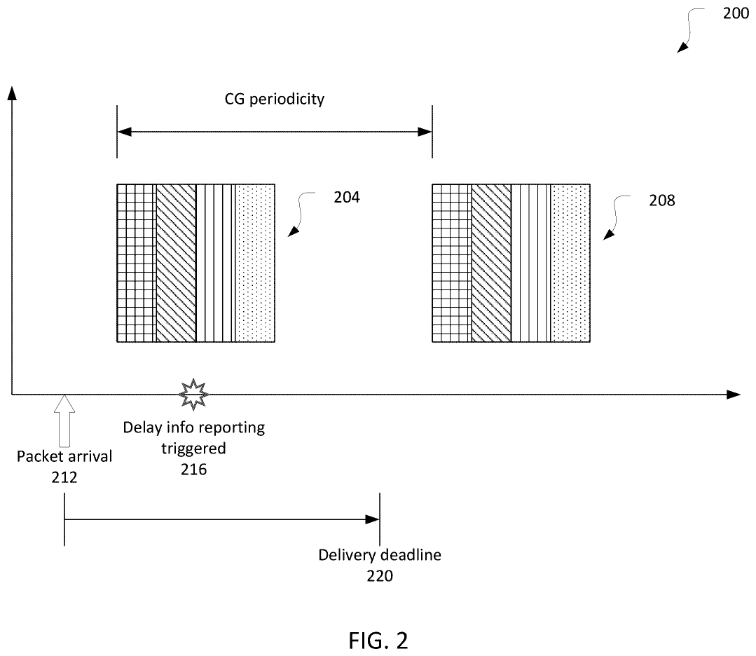

A CG configuration providing multi-physical uplink shared channel (PUSCH) CG cycles may be used for periodic traffic with varying packet sizes such as, for example, audio/video. FIG. 2 illustrates a CG configuration 200 with multi-PUSCH CG cycles to describe embodiments of the present disclosure.

The CG configuration 200 may configure a first CG cycle 204 and a second CG cycle 208. The start of the first CG cycle 204 may be separated from a start of the second CG cycle 208 by a CG periodicity. Each CG cycle may include a plurality of PUSCH opportunities. Each PUSCH opportunity may be associated with a different hybrid automatic repeat request (HARQ) process identifier (ID).

When the UE 104 has a large packet size to transmit, the UE 104 may be able to use all PUSCH opportunities in a CG cycle to make sure the packet is transmitted within its delivery deadline. When the UE 104 has a small packet size to transmit, the UE 104 may only use some PUSCH opportunities of a CG cycle. The UE 104 may then indicate which CG resources (for example, PUSCH opportunities) are not to be used, and the base station 108 may reallocate those resources to other UEs (or for other purposes) in order to improve spectral efficiency.

Consider, for example, that the CG configuration 200 is used for transmission of UL XR traffic with a delay information reporting requirement. A packet may arrive, from upper layers, at 212. At 216, delay information reporting for the packet may be triggered in the middle of the first CG cycle 204, for example, after the first two PUSCH opportunities but before the last two PUSCH opportunities of the first CG cycle 204. In some cases, the delay information reporting may not be necessary as the UE 104 may already foresee some upcoming resources (for example, the last two PUSCH opportunities within the first CG cycle 204) that is sufficient for it to complete transmitting the packet in time (for example, before the delivery deadline 220). Unnecessary triggering of delay information reporting may lead to additional overhead.

While FIG. 2 describes additional resources in the context of multi-PUSCH CG, similar issues may exist for any case in which the UE 104 can foresee some UL resources when the delay information reporting is triggered.

To address these issues, some embodiments describe conditional triggering of delay information reporting to ensure that the delay information is timely and appropriately transmitted.

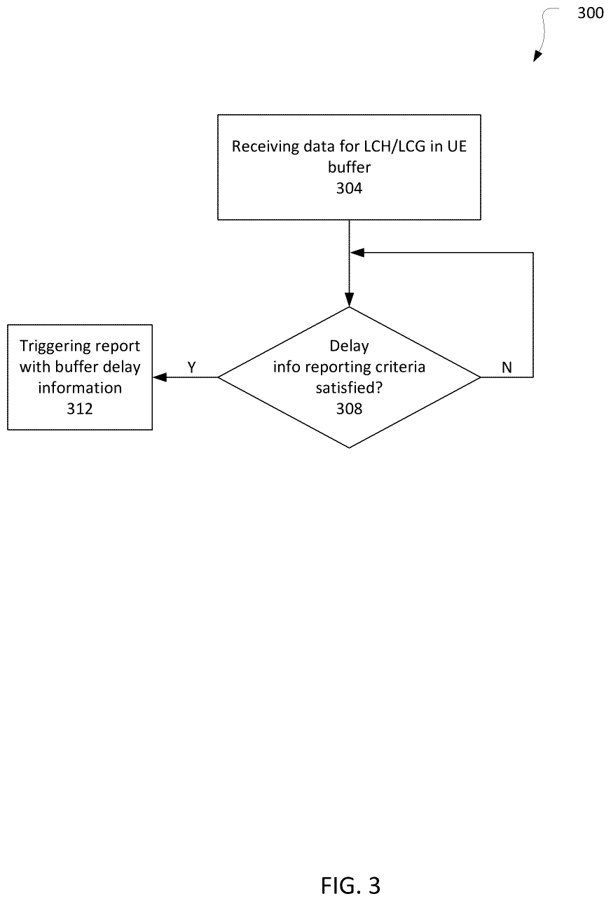

FIG. 3 illustrates an operation flow/algorithmic structure 300 in accordance with some embodiments. The operation flow/algorithmic structure 300 may be implemented by a UE such as, for example, UE 104 or 800 or components therein, for example, processors 804.

The operation flow/algorithmic structure 300 may include, at 304, receiving data for an LCH/LCG in a buffer of the UE. The data may be received from upper layers. The data may include one or more data units (for example, a packet, a group of packets, a PDU, a PDU set, etc.)

The operation flow/algorithmic structure 300 may further include, at 308, determining whether delay information reporting criteria is satisfied. The delay information reporting criteria may be as described with respect to one or more of the following options.

In a first option, the delay information reporting criteria is satisfied if two conditions are fulfilled. The first condition is that a remaining time until the delivery deadline of at least one buffered data unit is shorter than a predetermined threshold. The second condition is that the UE does not foresee sufficiently available UL resources that allows the UE to transmit the at least one buffered data unit before the delivery deadline. For example the UE 104 may determine the remaining time until a delivery deadline for at least one of the buffered packets becomes shorter than a threshold in a middle of a multi-PUSCH CG cycle. The UE 104 may then check to determine whether subsequent PUSCH opportunities within the same CG cycle (or subsequent CG cycle(s) if they are within the delivery deadline) are sufficient to transmit the at least one buffered packet completely.

To determine whether there are sufficiently available UL resources, the UE 104 may determine whether a quantity of the available resources is sufficient to accommodate the volume of data (for example, at least one of the buffered packets) that needs to be transmitted. In some instances, the packet size may be very large and the UE 104 may need to determine whether the available resources are sufficient to handle the data. The UE 104 may also determine whether the available resources are permitted to transmit data for the LCH/LCG to which the buffered data belongs. In some instances, available resources may not be allowed to carry data from a particular LCH/LCG due to, for example, potential LCH/LCG mapping restrictions.

In a second option, the delay information reporting criteria is satisfied if the UE does not foresee sufficiently available UL resources that allows the UE to transmit the one or more buffered data units before their delivery deadline. This may be similar to the second condition of the first option. However, with the second option, the first condition of the first option may not need to be considered. That is, the UE 104 does not consider the threshold for remaining time until the deliver deadline and, instead, can determine the delay information reporting criteria is satisfied as soon as it does not foresee sufficiently available UL resources that will allow the UE to completely transmit one or more buffered data unit before the delivery deadline.

In some embodiments, the second option may additionally consider whether the data unit arrives in the buffer when it is expected or whether the data unit arrives late. For example, the data unit may arrive in the middle of CG cycle of a multi-PUSCH CG. The late arrival may be due to jitter, for example. Thus, in some embodiments, the second option may include an additional condition of whether the data unit arrives in the buffer more than a predetermined period of time from an expected arrival of the data in the buffer. If the data unit arrives more than the predetermined period of time from the expected arrival time, and the UE does not foresee sufficiently available UL resources that allows the UE to completely transmit one or more of the buffered data units before the delivery deadline, then the UE 104 may determine the delay information reporting criteria is satisfied.

In some embodiments, the delay information reporting criteria of the first or second options may be further conditioned on a type of the buffered data. For example, for either the first or second option, the UE 104 may also consider an importance level of PDU sets of the data. If all the buffered data of an LCH/LCG has an importance level below a predetermined threshold (for example, all non-important PDU sets), the UE 104 may determine the delay information reporting criteria is not satisfied, even if the other conditions of the first or second options are fulfilled.

If, at 308, the UE 104 determines the delay information reporting criteria is satisfied, the operation flow/algorithmic structure 300 may advance to triggering a report with the buffer delay information at 312. The UE 104 may generate a MAC PDU/CE with the buffer delay information for transmission to the base station 108. Upon receiving the report, the base station 108 may allocate additional UL resources to allow the UE 104 to transmit the buffered data before the delivery deadline.

If the UE 104 determines the delay information reporting criteria is not satisfied at 308, the UE 104 may not trigger the delay information report for the given LCH/LCG. Instead, the operation flow/algorithmic structure 300 may continue to monitor the relevant conditions at 308 to determine whether the criteria becomes satisfied in the future. In some embodiments, the UE 104 may continuously monitor the conditions for the buffer delay information reporting criteria. In other embodiments, the UE 104 may re-check the conditions when certain events are detected. For example, if the sufficient resources determined to be available become unavailable, the UE 104 may check again to determine whether the delay information reporting criteria is satisfied. The resources may become unavailable if, for example, they are deprioritized by a high-priority transmission.

In some instances, the UE 104 may directly trigger the delay information reporting if specific events occur. For example, the UE 104 may directly trigger the report with the buffer delay information (or buffer size information) if a threshold number of the PUSCH opportunities of a multi-PUSCH CG cycle are deprioritized. This may be done with or without consideration of whether the remaining time until the deadline is below the predetermined threshold.

In some embodiments, after the UE 104 triggers the reporting of the delay information at 312, but before transmission of the report, the UE 104 may detect a cancellation event and cancel the triggered report. The cancellation event may include a determination that the triggering conditions are no longer fulfilled. For example, consider that the UE 104 triggered the delay information report because there was not sufficient/allowed UL resources for the UE 104 to transmit a buffered packet before its delivery deadline. However, before the triggered report is actually transmitted, the UE 104 receives further resource allocation (e.g. a dynamic grant) that is sufficient/allowed for the UE 104 to transmit the buffered packet before the delivery deadline. In this case, the UE may cancel the triggered delay information report.

In another embodiment, the cancellation event may occur if, before the triggered delay information report is transmitted, all buffered data above a predetermined importance threshold (for example, all important PDU Sets) are transmitted or discarded. In this case, the buffer transitions to only having data below the predetermined importance threshold (for example, all non-important PDU sets), if any data at all, and the UE 104 may cancel the triggered report.

In another embodiment, the cancellation event may occur if the UE 104 is able to multiplex the MAC CE for the triggered delay information report into a MAC PDU. In this situation, the delay information report is likely to be transmitted in advance of obtaining the UL resources based on the triggered event. Thus, the UE 104 may cancel the triggered event to prevent an unnecessary allocation of the UL resources.

In another embodiment, the cancellation event may occur if the UE 104 is able to multiplex the MAC CE for the triggered delay information report into a MAC PDU and the MAC PDU is successfully/completely transmitted. Thus, in this embodiment, the UE 104 may not cancel the triggered delay information report until it confirms the MAC PDU is successfully/completely transmitted. This may address a situation in which transmission of the MAC PDU is prevented due to, for example, de-prioritization or a listen-before-talk failure.

If the UE 104 detects a cancellation event and the UE 104 has also triggered a scheduling request (SR) for the triggered delay information report, the UE 104 may also cancel the pending SR and stop related ongoing random access procedures, if any, when the triggered delay information report is cancelled.

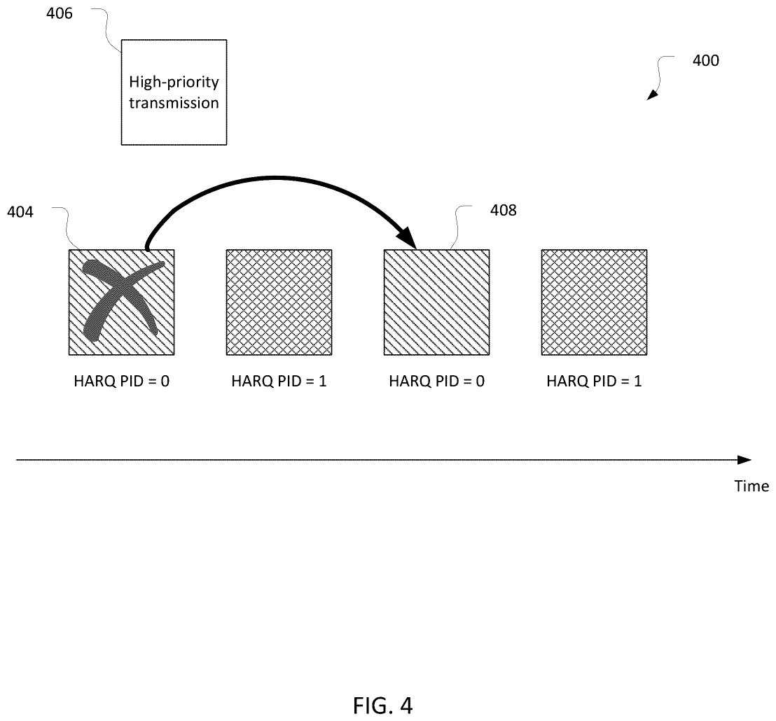

Another challenge of accurate and timely delay information reporting may relate to CG configurations with autonomous transmission enabled. FIG. 4 is a timing diagram 400 illustrating autonomous transmission in accordance with some embodiments. Once the delay information reporting is triggered, it can be transmitted on any UL shared channel (SCH) that is available to the UE 104, including a CG configured with autonomous transmission (AutoTX). For example, with reference to FIG. 4, consider that a MAC CE having the delay information report is multiplexed into a MAC PDU that is to be transmitted in PUSCH transmission 404 with a HARQ process ID 0. If the MAC PDU is de-prioritized by high-priority transmission 406 (for example, in the middle of the PUSCH transmission 404), AutoTx enables the UE 104 to autonomously transmit the MAC PDU in a second PUSCH transmission 408 with the same HARQ process ID (for example, HARQ process ID 0). However, the UE 104 can no longer change the delay information report in the MAC CE that is already multiplexed into the MAC PDU. When the base station 108 receives the MAC PDU, it may wrongly assume the MAC PDU/MAC CE was generated right before the second PUSCH transmission 408. Thus, the base station 108 may misinterpret the delay information in the MAC PDU (which is actually already outdated). In this instance, the delay information would not be up-to-date as desired. Thus, various embodiments describe how to configure autonomous transmissions in a manner that does not compromise accurate reporting of buffer delay information. This may be accomplished in accordance with one or more of the following options.

In a first option, resource restrictions may be introduced with respect to the delay information report. For example, any delay information report may not be allowed to be multiplexed into UL-SCH resources pertaining to a CG configuration with autonomous transmission enabled. In some examples, the delay information report may not be allowed to be multiplexed into an UL-SCH resource pertaining to a CG configuration with autonomous transmission enabled, if the UL-SCH resource (and the MAC PDU of which) could potentially be de-prioritized by another transmission (e.g. if there is another PUSCH or PUCCH at least partially overlaps in time with the UL-SCH resource, which may have higher priority than the UL-SCH resource); otherwise, the delay information report may still be allowed to be multiplexed into an UL-SCH resource pertaining to a CG configuration with autonomous transmission enabled. In some examples, only the delay information report of specific LCGs/LCHs are allowed to be multiplexed into UL-SCH resources pertaining to a CG configuration with autonomous transmission enabled. Thus, when the UE 104 generates a buffer delay information report, it may select resources from a dynamic grant or a CG configuration that does not have the autonomous transmission enabled for transmission of the report. In some embodiments, any delay information report may not be allowed to be multiplexed into UL-SCH resources pertaining to a CG configuration with lower priority (e.g. lower L1-priority), so de-prioritization of the delay information report could be avoided. In some other examples, only the delay information report of specific LCGs/LCHs are allowed to be multiplexed into UL-SCH resources pertaining to a CG configuration with lower priority (e.g. lower L1-priority), or a CG configuration that is only allowed to be used by specific LCHs (e.g. low priority LCHs). In some embodiments, if the UE 104 has two or more UL-SCH resources that are available for transmission of a delay information report which has been triggered, the UE 104 should select an UL-SCH resource with the highest priority for transmission of the triggered delay information report; alternatively, the UE 104 should refrain from selecting an UL-SCH resource with the lowest priority for transmission of the triggered delay information report. In some embodiments, such a resource restriction may be predefined in, for example, a 3GPP TS. In other embodiments, the network may dynamically configure the restriction.

In a second option, configuring both autonomous transmission and buffer delay information reporting of any LCH/LCG may not be permitted on the UE 104 or a MAC entity therein. For example, if any CG configuration has autonomous transmission enabled, the UE 104 may not be configured to trigger/transmit buffer delay information report of on any LCH/LCG. In some embodiments, such a configuration restriction may be predefined in, for example, a 3GPP TS. In other embodiments, the network may dynamically configure the restriction.

In a third option, the features of intra-UE prioritization (e.g. LCH-based prioritization or L1-prioritization) and buffer delay information reporting of any LCH/LCG may not be allowed to be configured together on the UE 104 or a MAC entity therein. For example, if intra-UE prioritization is enabled, the UE 104 may not be able to transmit buffer delay information reports of any LCH/LCG. In some embodiments, such a configuration restriction may be predefined in, for example, a 3GPP TS. In other embodiments, the network may dynamically configure the restriction.

In a fourth option, if the delay information report is included in UL-SCH resources pertaining to a CG configuration with autonomous transmission enabled, then the MAC PDU is NOT allowed to be de-prioritized by another transmission. For example, if a MAC PDU within the first PUSCH transmission 404 carries buffer delay information, it may not be deprioritized by the high-priority transmission 406. Thus, the UE 104 will complete transmission of the first PUSCH transmission 404 with the buffer delay information. The buffer delay information may then provide the base station 108 with up-to-date information of the buffer delay. In some embodiments, such a prioritization rule may be predefined in, for example, a 3GPP TS. In other embodiments, the network may dynamically configure the restriction.

In a fifth option, the UE 104 may use uplink signaling (for example, uplink control information (UCI)) to provide an indication of when a MAC PDU containing a delay information report was generated. By providing this indication, the base station 108 may be able to interpret the delay information report more accurately. This may be the case even if the MAC PDU carrying the report is autonomously transmitted by the UE 104.

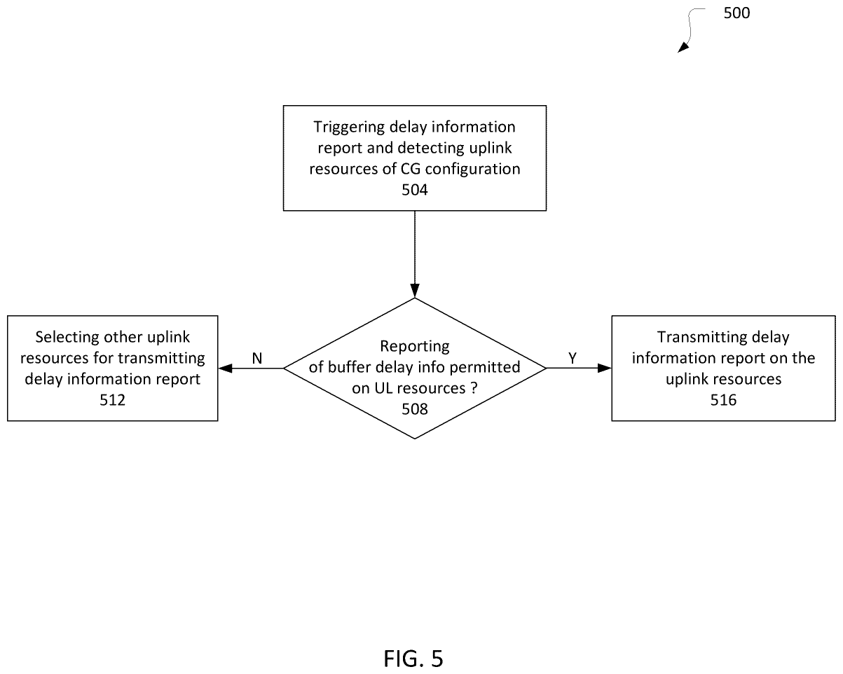

FIG. 5 illustrates an operation flow/algorithmic structure 500 in accordance with some embodiments. The operation flow/algorithmic structure 500 may be implemented by a UE such as, for example, UE 104 or 800 or components therein, for example, processors 804.

The operation flow/algorithmic structure 500 may include, at 504, triggering a delay information report and detecting uplink resources of a CG configuration. The delay information report may be triggered based on a conventional process or as described elsewhere herein including, for example, as described with respect to the operation flow/algorithmic structure 300. The buffer delay information may be associated with data for an LCH/LCG received in a buffer of the UE.

The operation flow/algorithmic structure 500 may further include, at 508, determining whether reporting of the buffer delay information is permitted on the uplink resources of the CG configuration.

In some embodiments, the determining at 508 may be based on whether autonomous transmission is enabled by the CG configuration. For example, if autonomous transmission is not enabled for the CG configuration, it may be determined that reporting of the buffer delay information is permitted on the uplink resources. Conversely, if autonomous transmission is enabled for the CG configuration, it may be determined that reporting of the buffer delay information is not permitted on the uplink resources. In some embodiments, the determining at 508 may be further based on whether the uplink resources may potentially be de-prioritized by any other transmission (such as another PUSCH/PUCCH with higher priority) that overlaps with the uplink resources in time. For example, if autonomous transmission is enabled for the CG configuration, it may be determined that reporting of the buffer delay information is permitted on the uplink resources is still permitted as long as this is not overlapping with another transmission in time that could potentially be prioritized over the uplink resources.

In some embodiments, the determining at 508 may be based on whether autonomous transmission is enabled by any CG configuration of the UE or a MAC entity of the UE. For example, if autonomous transmission is not enabled for any CG configuration of the UE or the MAC entity, it may be determined that reporting of the buffer delay information is permitted on the uplink resources. Conversely, if autonomous transmission is enabled for any CG configuration of the UE or the MAC entity (even if it is a CG configuration different from the CG configuration of the selected uplink resources), it may be determined that reporting of the buffer delay information is not permitted on the selected uplink resources.

In some embodiments, the determining at 508 may be based on priority information. For example, in some embodiments, any delay information report may not be allowed to be multiplexed into UL-SCH resources pertaining to a CG configuration with lower priority (e.g. lower L1-priority). In some other examples, only the delay information report of specific LCGs/LCHs are allowed to be multiplexed into UL-SCH resources pertaining to a CG configuration with lower priority (e.g. lower L1-priority), or a CG configuration that is only allowed to be used by specific LCHs (e.g. low priority LCHs). In some embodiments, if the UE 104 has two or more UL-SCH resources that are available for transmission of a delay information report which has been triggered, the UE 104 should select an UL-SCH resource with the highest priority for transmission of the triggered delay information report; alternatively, the UE 104 should refrain from selecting an UL-SCH resource with the lowest priority for transmission of the triggered delay information report.

In some embodiments, the determining at 508 may be based on whether intra-UE prioritization is enabled for the UE or a MAC entity of the UE. For example, if intra-UE prioritization is not enabled for the UE or the MAC entity, it may be determined that reporting of the buffer delay information is permitted on any uplink resources. Conversely, if intra-UE prioritization is enabled for the UE or the MAC entity, it may be determined that reporting of the buffer delay information is not permitted.

If it is determined, at 508, that the reporting of the buffer delay information is permitted on the uplink resources, the operation flow/algorithmic structure 500 may advance to transmitting the delay information report on the uplink resources. The transmitting of the delay information report on the uplink resources may include generation of a MAC PDU having the buffer delay information. In some embodiments, once the MAC PDU is generated with the buffer delay information, the UE may prioritize transmission of the MAC PDU over the other transmission(s), even if the other transmission(s) have higher priority by default. In additional/alternative embodiments, once the MAC PDUs generated with the buffer delay information, the UE may transmit UCI or other signaling to indicate, to the base station, that the MAC PDU has the buffer delay information.

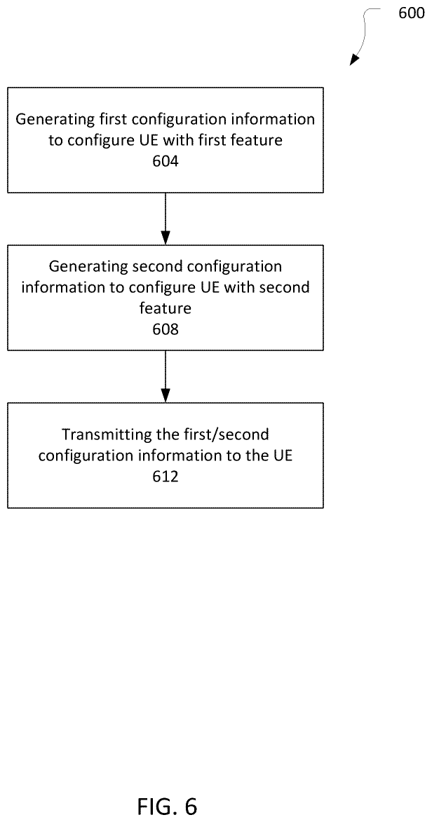

FIG. 6 illustrates an operation flow/algorithmic structure 600 in accordance with some embodiments. The operation flow/algorithmic structure 600 may be implemented by a base station such as, for example, base station 108 or 900 or components therein, for example, processors 904.

The operation flow/algorithmic structure 600 may include, at 604, generating first configuration information to configure a UE with respect to a first feature. The first feature may be a first one of: (a) buffer delay information reporting feature; or (b) an autonomous transmission feature or an intra-UE prioritization feature.

The operation flow/algorithmic structure 600 may further include, at 608, generating second configuration information to configure a UE with respect to a second feature. The second feature may be a second one of: (a) the buffer delay information reporting feature; or (b) the autonomous transmission feature or the intra-UE prioritization feature.

In some embodiments, the first and second configuration information may be dependent upon one another. For example, the second configuration information may be generated based on the first configuration information. In another example, the feature corresponding to the first configuration information and the feature corresponding to the second configuration information cannot be enabled/applied at a UE concurrently. In this manner, the different features may be configured to avoid transmission of outdated buffer delay information to the network.

In an embodiment in which the first feature is the delay information reporting feature and the second feature is the autonomous transmission feature, the first configuration information may configure the UE with a first LCH/LCG having the delay information reporting feature enabled and the second configuration information may configure the UE with the first CG configuration having the autonomous transmission feature disabled.

In an embodiment in which the second feature is the delay information reporting feature and the first feature is an autonomous transmission feature, the first configuration information may configure the UE with at least one CG configuration having the autonomous transmission feature enabled and the second configuration information may configure the UE with the delay information reporting feature disabled on some LCHs/LCGs.

In an embodiment in which the second feature is the delay information reporting feature and the first feature is an intra-UE prioritization feature, the first configuration information may configure the UE with the intra-UE prioritization feature enabled, and the second configuration information may configure the UE with the delay information reporting feature disabled.

When buffer delay information reporting is triggered due to the availability of padding bits in a transmission opportunity (e.g. a configured grant or a dynamic grant), the UE may determine a number of buffered packets or a number of LCHs/LCGs whose delay information is to be reported using the available padding bits, based on the number of available padding bits. The UE may build the MAC CE (e.g. BSR) accordingly, or select the appropriate MAC CE format (e.g. BSR format) for buffer delay information reporting using the padding bits, based on the determining. The packet can be referred to as any data unit (e.g. a data burst, a PDU, or a PDU Set) or any portion of the buffered data.

In some embodiments, if the number of padding bits is equal to or larger than the size of the MAC CE (e.g. BSR) including buffer delay information of a first number of buffered packet and/or a first number of LCH/LCG plus its subheader, but smaller than the size of the MAC CE including buffer delay information of a second number of buffered packets and/or a second number of LCHs/LCGs plus its subheader, the UE may select the MAC CE format with buffer delay information of the first number of buffered packet and/or the first number of LCH/LCG for buffer delay information reporting using the padding bits. Otherwise, if the number of padding bits is equal to or larger than the size of the MAC CE (e.g. BSR) including buffer delay information of the second number of buffered packets and/or the second number of LCHs/LCGs plus its subheader, the UE may select the MAC CE format with buffer delay information of the second number of buffered packets and/or the second number of LCHs/LCGs for buffer delay information reporting using the padding bits. In some examples, the first number is one, and the second number is any number larger than one.

In some embodiments, if the number of padding bits is equal to or larger than the size of the MAC CE (e.g. BSR) including buffer delay information of only one buffered packet or only one LCH/LCG plus its subheader, but smaller than the size of the MAC CE including buffer delay information of multiple buffered packets and/or multiple LCHs/LCGs plus its subheader, the UE may select the MAC CE format with buffer delay information of only one buffered packet and/or only one LCH/LCG for buffer delay information reporting using the padding bits. Otherwise, if the number of padding bits is equal to or larger than the size of the MAC CE (e.g. BSR) including buffer delay information of multiple buffered packets and/or multiple LCHs/LCGs plus its subheader, the UE may select the MAC CE format with buffer delay information of multiple buffered packets and/or multiple LCHs/LCGs for buffer delay information reporting using the padding bits.

In some embodiments, the UE may further consider the number of buffered packets whose triggering conditions of delay information reporting are satisfied, or the number of LCHs/LCGs that have data available for transmission, when selecting the MAC CE format for buffer delay information reporting.

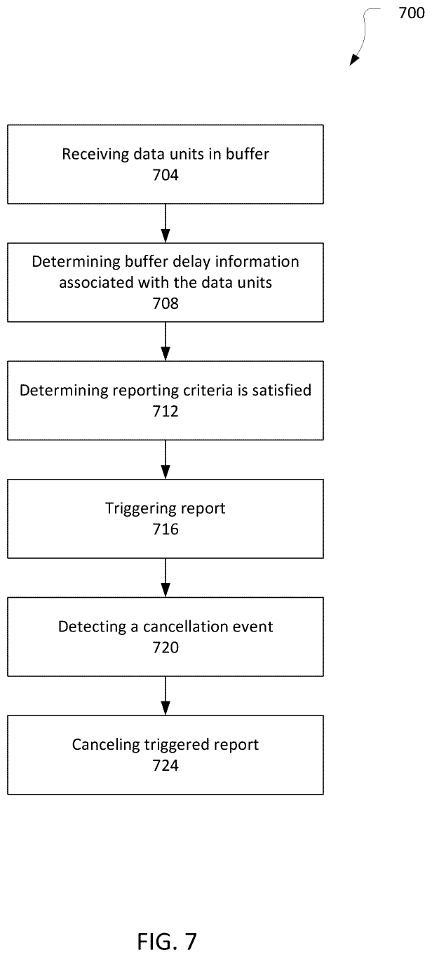

FIG. 7 illustrates an operation flow/algorithmic structure 700 in accordance with some embodiments. The operation flow/algorithmic structure 700 may be implemented by a UE such as, for example, UE 104 or 800 or components therein, for example, processors 804.

The operation flow/algorithmic structure 700 may include, at 704, receiving data units in a buffer. For example, one or more data units for an LCH/LCG may be received in a buffer of a UE. The one or more data units may be associated with a delivery deadline.

The operation flow/algorithmic structure 700 may further include, at 708, determining buffer delay information associated with the data units.

The operation flow/algorithmic structure 700 may further include, at 712, determining reporting criteria is satisfied.

The operation flow/algorithmic structure 700 may further include, at 716, triggering a report. The report may be for the buffer delay information. The triggering of the report may be based on determining the reporting criteria is satisfied.

The operation flow/algorithmic structure 700 may further include, at 720, detecting a cancelation event. Detecting the cancelation event may include determining the reporting criteria is no longer satisfied, determining the delay information is transmitted in a MAC CE, or determining the one or more data units are transmitted or discarded.

The operation flow/algorithmic structure 700 may further include, at 720, canceling the triggered report. If a random access procedure was initiated for a scheduling request based on the report triggered at 716, the operation flow/algorithmic structure 700 may include stopping the random access procedure based on canceling the triggered report.

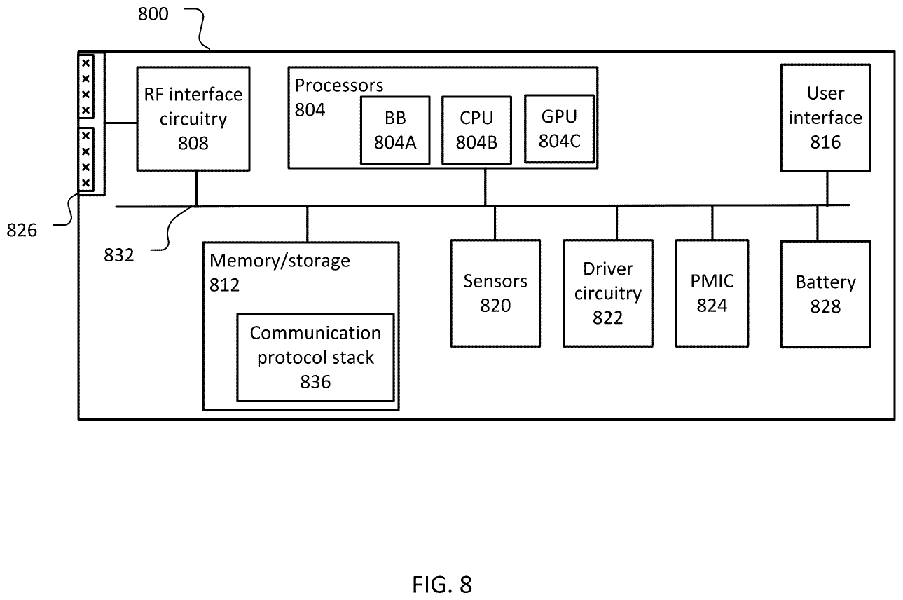

FIG. 8 illustrates a UE 800 in accordance with some embodiments. The UE 800 may be similar to and substantially interchangeable with UE 104 of FIG. 1.

The UE 800 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smart watch), or Internet-of-things device.

The UE 800 may include processors 804, RF interface circuitry 808, memory/storage 812, user interface 816, sensors 820, driver circuitry 822, power management integrated circuit (PMIC) 824, antenna structure 826, and battery 828. The components of the UE 800 may be implemented as integrated circuits (ICs), portions thereof, discrete electronic devices, or other modules, logic, hardware, software, firmware, or a combination thereof. The block diagram of FIG. 8 is intended to show a high-level view of some of the components of the UE 800. However, some of the components shown may be omitted, additional components may be present, and different arrangement of the components shown may occur in other implementations.

The components of the UE 800 may be coupled with various other components over one or more interconnects 832, which may represent any type of interface, input/output, bus (local, system, or expansion), transmission line, trace, or optical connection that allows various circuit components (on common or different chips or chipsets) to interact with one another.

The processors 804 may include processor circuitry such as, for example, baseband processor circuitry (BB) 804A, central processor unit circuitry (CPU) 804B, and graphics processor unit circuitry (GPU) 804C. The processors 804 may include any type of circuitry or processor circuitry that executes or otherwise operates computer-executable instructions, such as program code, software modules, or functional processes from memory/storage 812 to cause the UE 800 to perform BSR-related operations as described herein.

In some embodiments, the baseband processor circuitry 804A may access a communication protocol stack 836 in the memory/storage 812 to communicate over a 3GPP compatible network. In general, the baseband processor circuitry 804A may access the communication protocol stack 836 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 808.

The baseband processor circuitry 804A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 812 may include one or more non-transitory, computer-readable media that includes instructions (for example, communication protocol stack 836) that may be executed by one or more of the processors 804 to cause the UE 800 to perform various operations described herein. These operations include, but are not limited to, the operation flows/algorithmic structures 300 and 500.

The memory/storage 812 include any type of volatile or non-volatile memory that may be distributed throughout the UE 800. In some embodiments, some of the memory/storage 812 may be located on the processors 804 themselves (for example, L1 and L2 cache), while other memory/storage 812 is external to the processors 804 but accessible thereto via a memory interface. The memory/storage 812 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 808 may include transceiver circuitry and radio frequency front module (RFEM) that allows the UE 800 to communicate with other devices over a radio access network. The RF interface circuitry 808 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 826 and proceed to filter and amplify (with a low-noise amplifier) the signal. The signal may be provided to a receiver of the transceiver that down-converts the RF signal into a baseband signal that is provided to the baseband processor of the processors 804.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna structure 826.

In various embodiments, the RF interface circuitry 808 may be configured to transmit/receive signals in a manner compatible with NR access technologies.

The antenna structure 826 may include antenna elements to convert electrical signals into radio waves to travel through the air and to convert received radio waves into electrical signals. The antenna elements may be arranged into one or more antenna panels. The antenna structure 826 may have antenna panels that are omnidirectional, directional, or a combination thereof to enable beamforming and multiple input, multiple output communications. The antenna structure 826 may include microstrip antennas, printed antennas fabricated on the surface of one or more printed circuit boards, patch antennas, or phased array antennas. The antenna structure 826 may have one or more panels designed for specific frequency bands including bands in FR1 or FR2.

The user interface 816 includes various input/output (I/O) devices designed to enable user interaction with the UE 800. The user interface 816 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 800.

The sensors 820 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 822 may include software and hardware elements that operate to control particular devices that are embedded in the UE 800, attached to the UE 800, or otherwise communicatively coupled with the UE 800. The driver circuitry 822 may include individual drivers allowing other components to interact with or control various I/O devices that may be present within, or connected to, the UE 800. For example, the driver circuitry 822 may include a display driver to control and allow access to a display device, a touchscreen driver to control and allow access to a touchscreen interface, sensor drivers to obtain sensor readings of sensors 820 and control and allow access to sensors 820, drivers to obtain actuator positions of electro-mechanic components or control and allow access to the electro-mechanic components, a camera driver to control and allow access to an embedded image capture device, audio drivers to control and allow access to one or more audio devices.

The PMIC 824 may manage power provided to various components of the UE 800. In particular, with respect to the processors 804, the PMIC 824 may control power-source selection, voltage scaling, battery charging, or DC-to-DC conversion.

In some embodiments, the PMIC 824 may control, or otherwise be part of, various power saving mechanisms of the UE 800 including DRX as discussed herein.

A battery 828 may power the UE 800, although in some examples the UE 800 may be mounted deployed in a fixed location, and may have a power supply coupled to an electrical grid. The battery 828 may be a lithium ion battery, a metal-air battery, such as a zinc-air battery, an aluminum-air battery, a lithium-air battery, and the like. In some implementations, such as in vehicle-based applications, the battery 828 may be a typical lead-acid automotive battery.

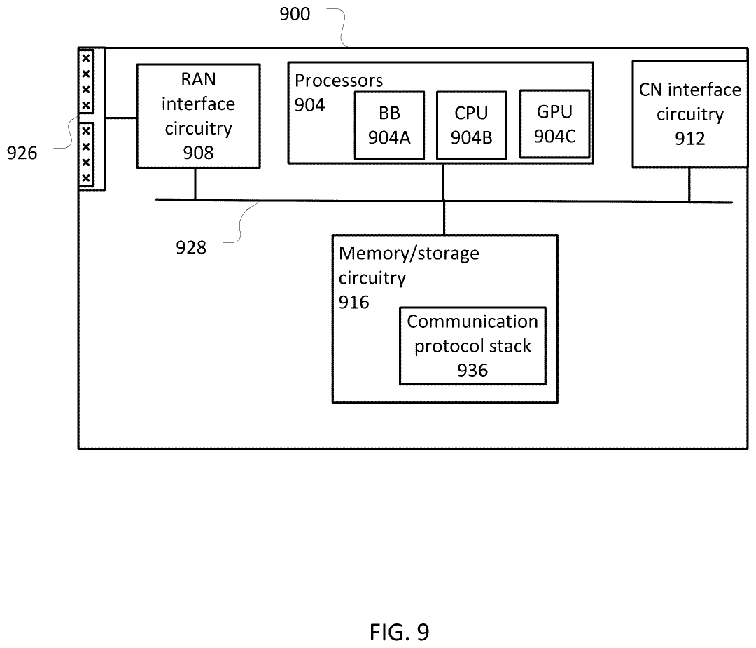

FIG. 9 illustrates a base station 900 in accordance with some embodiments. The base station 900 may be similar to and substantially interchangeable with base station 108.

The base station 900 may include processors 904, RF interface circuitry 908, core network (CN) interface circuitry 912, memory/storage circuitry 916, and antenna structure 926. The components of the base station 900 may be coupled with various other components over one or more interconnects 928.

The processors 904, RF interface circuitry 908, memory/storage circuitry 916 (including communication protocol stack 936), antenna structure 926, and interconnects 928 may be similar to like-named elements shown and described with respect to FIG. 8.

The memory/storage 916 may include one or more non-transitory, computer-readable media that includes instructions (for example, communication protocol stack 936) that may be executed by one or more of the processors 904 to cause the base station 900 to perform various operations described herein. These operations include, but are not limited to, the operation flow/algorithmic structure 600.

The CN interface circuitry 912 may provide connectivity to a core network, for example, a 5th Generation Core network (5GC) using a 5GC-compatible network interface protocol such as carrier Ethernet protocols, or some other suitable protocol. Network connectivity may be provided to/from the base station 900 via a fiber optic or wireless backhaul. The CN interface circuitry 912 may include one or more dedicated processors or FPGAs to communicate using one or more of the aforementioned protocols. In some implementations, the CN interface circuitry 912 may include multiple controllers to provide connectivity to other networks using the same or different protocols.

In some embodiments, the base station 900 may be coupled with transmit receive points (TRPs) using the antenna structure 926, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

In the following sections, further exemplary aspects are provided.

Example 1 includes a method comprising: receiving one or more data units for a logical channel (LCH)/logical channel group (LCG) in a buffer of a user equipment (UE), the one or more data units associated with a delivery deadline; determining buffer delay information associated with the one or more data units; determining reporting criteria is satisfied; triggering a report for the buffer delay information based on said determining the reporting criteria is satisfied; detecting a cancellation event; and canceling said triggering of the report based on detecting the cancellation event.

Example 2 includes the method of claim 1 or some other example herein, wherein the reporting criteria includes insufficient uplink resources allocated to permit transmission of the one or more data units before the delivery deadline.

Example 3 includes the method of example 2 or some other example herein, wherein determining the reporting criteria is satisfied comprises: identifying configured grant (CG) resources that occur before the delivery deadline; determining the CG resources are available for transmissions related to the LCH/LCG; and determining the CG resources do not have a capacity sufficient to accommodate the one or more data units.

Example 4 includes the method of example 3 or some other example herein, wherein the CG resources are within a multi-physical uplink shared channel (PUSCH) CG cycle.

Example 5 includes the method of example 1 or some other example herein, wherein detecting the cancellation event comprises: determining the reporting criteria is no longer satisfied.

Example 6 includes a method of example 1 or some other example herein, wherein detecting the cancellation event comprises: determining the delay information is transmitted in a media access control (MAC) control element (CE).

Example 7 includes a method of example 1 or some other example herein, wherein detecting the cancellation event comprises: determining the one or more data units are transmitted or discarded.

Example 8 includes method of example 1 or some other example herein, wherein the reporting criteria includes a remaining time until a delivery deadline being shorter than a predetermined threshold.

Example 9 includes the method of example 1 or some other example herein, wherein the reporting criteria includes the one or more data units comprising a protocol data unit (PDU) set associated with an importance level above a predetermined threshold.

Example 10 includes a method of example 9 or some other example herein, further comprising: initiating a random access procedure for a scheduling request based on triggering the report; and stopping the random access procedure based on canceling said triggering of the report.

Example 11 includes a method of example 1 or some other example herein, wherein the reporting criteria further includes the one or more data units comprising a protocol data unit (PDU) set associated with an importance level above a predetermined threshold.

Example 12 includes the method of example 1 or some other example herein, wherein the reporting criteria further includes the one or more data units arriving in a buffer of the UE more than a predetermined period of time from an expected arrival of the one or more data units in the buffer.

Example 13 includes a method to be implemented by a user equipment (UE), the method comprising: receiving one or more data units for a logical channel (LCH)/logical channel group (LCG) in a buffer of the UE; identifying a configured grant (CG) configuration to configure uplink resources; and determining whether reporting of buffer delay information associated with the one or more data units is permitted on the uplink resources.

Example 14 includes a method of example 13 or some other example herein, further comprising: determining autonomous transmission is not enabled by the CG configuration; and determining reporting of the buffer delay information is permitted on the uplink resources based on said determining the autonomous transmission is not enabled for the CG configuration.

Example 15 includes the method of example 13 or some other example herein, further comprising: determining autonomous transmission is enabled for at least one CG configuration of the UE or a media access control (MAC) entity of the UE; and determining reporting of the buffer delay information is not permitted on the uplink resources based on said determining autonomous transmission is enabled for at least one CG configuration of the UE.

Example 16 includes a method of example 13 or some other example herein, further comprising: determining an intra-UE prioritization is enabled for the UE or a media access control (MAC) entity of the UE; and determining reporting of the buffer delay information is not permitted on the uplink resources based on said determining the intra-UE prioritization is enabled for the UE or the MAC entity of the UE.

Example 17 includes a method of example 13 or some other example herein, wherein autonomous transmission is enabled by the CG configuration and the method further comprises: determining reporting of the buffer delay information is permitted on the uplink resources; generating a media access control (MAC) protocol data unit (PDU) having the buffer delay information, the MAC PDU to be transmitted on the uplink resources; and prioritizing a transmission of the MAC PDU over another transmission.

Example 18 includes a method of example 13 or some other example herein, wherein autonomous transmission is enabled by the CG configuration and the method further comprises: determining reporting of the buffer delay information is permitted on the uplink resources; generating a media access control (MAC) protocol data unit (PDU) having the buffer delay information, the MAC PDU to be transmitted on the uplink resources; and transmitting uplink control information to indicate the MAC PDU has the buffer delay information.

Example 19 includes a method comprising: generating first configuration information to configure a user equipment (UE) with respect to a first feature; generating second configuration information to configure the UE with respect a second feature based on the first configuration, wherein a first one of the first feature or second feature is a delay information reporting feature and a second one of the first feature or the second feature is an autonomous transmission feature or an intra-UE prioritization feature; and transmitting the first and second configuration information to the UE.

Example 20 includes the method of example 19 or some other example herein, wherein the first feature is the delay information reporting feature, the second feature is an autonomous transmission feature, the first configuration information is to configure the UE with a logical channel/logical channel group having the delay information reporting feature enabled, and the second configuration information is to configure the UE with a CG configuration having the autonomous transmission feature disabled.

Example 21 includes the method of example 19 or some other example herein, wherein the second feature is the delay information reporting feature, the first feature is an autonomous transmission feature, the first configuration information is to configure the UE with at least one configured grant (CG) configuration having the autonomous transmission feature enabled, and the second configuration information is to configure the UE with the delay information reporting feature disabled for all logical channels/logical channel groups.

Example 22 includes a method of example 19 or some other example herein, wherein the second feature is the delay information reporting feature, the first feature is an intra-UE prioritization feature, the first configuration information is to configure the UE with the intra-UE prioritization feature enabled, and the second configuration information is to configure the UE with the delay information reporting feature disabled on all logical channel/logical channel groups.

Example 23 includes a method comprising: receiving one or more data units for a logical channel (LCH)/logical channel group (LCG) in a buffer of the UE, the one or more data units associated with a delivery deadline; determining buffer delay information associated with the one or more data units; determining whether reporting criteria is satisfied, wherein the reporting criteria includes insufficient uplink resources allocated to permit transmission of the one or more data units before the delivery deadline; and determining whether to trigger a report with the buffer delay information based on said determining whether the reporting criteria is satisfied.

Example 24 includes the method of example 23 or some other example herein, wherein determining whether the reporting criteria satisfied includes determining the reporting criteria is satisfied and the method further comprises: triggering the report with the buffer delay information based on said determining the reporting criteria is satisfied.

Example 25 includes the method of example 24 some other example herein, wherein determining the reporting criteria is satisfied comprises: identifying configured grant (CG) resources that occur before the delivery deadline; determining the CG resources are available for transmissions related to the LCH/LCG; and determining the CG resources do not have a capacity sufficient to accommodate the one or more data units.

Example 26 includes the method of example 25 or some other example herein, wherein the CG resources are within a multi-physical uplink shared channel (PUSCH) CG cycle.

Example 27 includes the method of example 24 some other example herein, further comprising: detecting a cancellation event; and canceling said triggering of the report based on detecting the cancellation event.

Another example may include an apparatus comprising logic, modules, or circuitry to perform one or more elements of a method described in or related to any of examples 1-27, or any other method or process described herein.

Another example may include a method, technique, or process as described in or related to any of examples 1-27, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-27, or portions thereof.

Another example include a signal as described in or related to any of examples 1-27, or portions or parts thereof.

Another example may include a datagram, information element, packet, frame, segment, PDU, or message as described in or related to any of examples 1-27, or portions or parts thereof, or otherwise described in the present disclosure.

Another example may include a signal encoded with data as described in or related to any of examples 1-27, or portions or parts thereof, or otherwise described in the present disclosure.

Another example may include a signal encoded with a datagram, IE, packet, frame, segment, PDU, or message as described in or related to any of examples 1-27, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-27, or portions thereof.

Another example may include a computer program comprising instructions, wherein execution of the program by a processing element is to cause the processing element to carry out the method, techniques, or process as described in or related to any of examples 1-27, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
receiving one or more data units for a logical channel (LCH)/logical channel group (LCG) in a buffer of a user equipment (UE), the one or more data units associated with a delivery deadline;
determining buffer delay information associated with the one or more data units;
determining reporting criteria is satisfied;
triggering a report for the buffer delay information based on said determining the reporting criteria is satisfied;
detecting a cancellation event; and
canceling said triggering of the report based on detecting the cancellation event.

2. The method of claim 1, wherein the reporting criteria includes insufficient uplink resources allocated to permit transmission of the one or more data units before the delivery deadline.

3. The method of claim 2, wherein determining the reporting criteria is satisfied comprises:
identifying configured grant (CG) resources that occur before the delivery deadline;
determining the CG resources are available for transmissions related to the LCH/LCG; and
determining the CG resources do not have a capacity sufficient to accommodate the one or more data units.

4. The method of claim 3, wherein the CG resources are within a multi-physical uplink shared channel (PUSCH) CG cycle.

5. The method of claim 1, wherein detecting the cancellation event comprises:
determining the reporting criteria is no longer satisfied.

6. The method of claim 1, wherein detecting the cancellation event comprises:
determining the delay information is transmitted in a media access control (MAC) control element (CE).

7. The method of claim 1, wherein detecting the cancellation event comprises:
determining the one or more data units are transmitted or discarded.

8. The method of claim 1, wherein the reporting criteria includes a remaining time until a delivery deadline being shorter than a predetermined threshold.

9. The method of claim 1, wherein the reporting criteria includes the one or more data units comprising a protocol data unit (PDU) set associated with an importance level above a predetermined threshold.

10. The method of claim 1, further comprising:
initiating a random access procedure for a scheduling request based on triggering the report; and
stopping the random access procedure based on canceling said triggering of the report.

11. One or more non-transitory, computer-readable media having instructions that, when executed, cause processing circuitry to:
receive one or more data units for a logical channel (LCH)/logical channel group (LCG) in a buffer of a user equipment (UE);
identify a configured grant (CG) configuration to configure uplink resources; and
determine whether reporting of buffer delay information associated with the one or more data units is permitted on the uplink resources.

12. The one or more non-transitory, computer-readable media of claim 11, wherein the instructions, when executed, further cause the processing circuitry to:
determine autonomous transmission is not enabled by the CG configuration; and
determine reporting of the buffer delay information is permitted on the uplink resources based on said determination that the autonomous transmission is not enabled for the CG configuration.

13. The one or more non-transitory, computer-readable media of claim 12, wherein the instructions, when executed, further cause the processing circuitry to:
determine autonomous transmission is enabled for at least one CG configuration of the UE or a media access control (MAC) entity of the UE; and
determine reporting of the buffer delay information is not permitted on the uplink resources based on said determination autonomous transmission is enabled for at least one CG configuration of the UE.

14. The one or more non-transitory, computer-readable media of claim 11, wherein the instructions, when executed, further cause the processing circuitry to:
determine an intra-UE prioritization is enabled for the UE or a media access control (MAC) entity of the UE; and
determine reporting of the buffer delay information is not permitted on the uplink resources based on said determination the intra-UE prioritization is enabled for the UE or the MAC entity of the UE.

15. The one or more non-transitory, computer-readable media of claim 11, wherein autonomous transmission is enabled by the CG configuration and the instructions, when executed, further cause the processing circuitry to:
determine reporting of the buffer delay information is permitted on the uplink resources;
generate a media access control (MAC) protocol data unit (PDU) having the buffer delay information, the MAC PDU to be transmitted on the uplink resources; and
prioritize a transmission of the MAC PDU over another transmission.

16. The one or more non-transitory, computer-readable media of claim 11, wherein autonomous transmission is enabled by the CG configuration and the instructions, when executed, further cause the processing circuitry to:
determine reporting of the buffer delay information is permitted on the uplink resources;
generate a media access control (MAC) protocol data unit (PDU) having the buffer delay information, the MAC PDU to be transmitted on the uplink resources; and
transmit uplink control information to indicate the MAC PDU has the buffer delay information.

17. A baseband processor comprising:
processing circuitry to:
generate first configuration information to configure a user equipment (UE) with respect to a first feature;
generate second configuration information to configure the UE with respect a second feature based on the first configuration, wherein a first one of the first feature or second feature is a delay information reporting feature and a second one of the first feature or the second feature is an autonomous transmission feature or intra-UE prioritization feature; and
interface circuitry coupled with the processing circuitry, the interface circuitry to communicatively couple the processing circuitry to a component of a device.

18. The baseband processor of claim 17, wherein the first feature is the delay information reporting feature, the second feature is an autonomous transmission feature, the first configuration information is to configure the UE with a logical channel/logical channel group having the delay information reporting feature enabled, and the second configuration information is to configure the UE with a CG configuration having the autonomous transmission feature disabled.

19. The baseband processor of claim 17, wherein the second feature is the delay information reporting feature, the first feature is an autonomous transmission feature, the first configuration information is to configure the UE with at least one configured grant (CG) configuration having the autonomous transmission feature enabled, and the second configuration information is to configure the UE with the delay information reporting feature disabled for all logical channels/logical channel groups.

20. The baseband processor of claim 17, wherein the second feature is the delay information reporting feature, the first feature is an intra-UE prioritization feature, the first configuration information is to configure the UE with the intra-UE prioritization feature enabled, and the second configuration information is to configure the UE with the delay information reporting feature disabled on all logical channel/logical channel groups.
